(19) United States
(12) Patent Application Publication
(10) Pub. No.: US 2004/0260954 A1
(43) Pub. Date: Dec. 23, 2004

(54) Biometrics PLC access and control system and method

(75) Inventor: Carl P. Morse, Milford, NH (US)

Correspondence Address: SQUARE D COMPANY, INTELLECTUAL PROPERTY DEPARTMENT, 1415 SOUTH ROSELLE ROAD, PALATINE, IL, 60067, US

(73) Assignee: Schneider Automation Inc.

(21) Appl. No.: 10/465,107

(22) Filed: Jun. 19, 2003

(51) Int. Cl. H04L 9/32

(52) U.S. Cl. 713/202

(57) ABSTRACT

A system for providing access to a PLC controlled subcomponent of an automation system. The system comprises a biometric identification device coupled to an I/O device of the automation system. The I/O device is configured to process input from the biometric identification device and provide an identification code for a user of the biometric identification device. The system further comprises a PLC based server configured to receive the identification code generated by the I/O device and process the identification code to determine whether to provide access to a PLC controlled subcomponent of the automation system to the user.

### RELATED APPLICATIONS

The present application is being filed concurrently with applications for “System And Method For Voice Input To An Automation System” (Attorney Docket No. SAA-95 (402P₃ 11)), serial number unknown at present; “System And Method For Ocular Input To An Automation System” (Attorney Docket No. SAA-96 (402P312)), serial number unknown at present; and “System And Method For Voice Output From An Automation System” (Attorney Docket No. SAA-97 (402P313)), serial number unknown at present; which are incorporated herein by reference. These applications have the same the inventor.

### TECHNICAL FIELD

The present invention is generally related to the use of biometric authentication devices to limit or control access to a PLC controlled apparatuses or a PLC process, and more particularly to a system and method utilizing a biometric authentication device as an input to a PLC controlled apparatus or a PLC process to manage access security in an industrial automation environment.

### BACKGROUND OF THE INVENTION

Biometric authentication is broadly defined as any authentication or identification scheme based on a physical attribute, such as DNA, retinal or iris patterns, fingerprints, facial features or voice printing. Biometric-based authentication devices measure, scan or otherwise analyze such physical attributes and compare the measured attributes with a database of previously recorded information regarding such attributes to positively identify a user of the system.

Although biometric devices have been around for nearly a decade, such devices have not been used to provide direct access to an apparatus or device at the I/O level in an automation system. Instead, biometric devices have only been implemented at the control level of a system, to provide access to the controlling computer (e.g., in a control booth associated with an automation system), or to control access to a door or other similar structure. Such practices did not provide for controlling access to each of the plurality of apparatuses or systems used in the automation environment.

In many factories, PLCs are used for safety applications (including applications that are life critical). The traditional PLC is protected from program and data changes by requiring a password. However, password protection is not sufficiently secure, as such protection can be changed or worked around. Changes in programs are particularly a problem when safety overrides are bypassed or when unauthorized program changes are made. Accordingly, a more secure system for providing access to PLC processes and PLC controlled apparatuses or systems is needed.

### SUMMARY OF THE INVENTION

The present invention provides a system for utilizing biometric authentication to control access to devices and systems in an industrial automation system or environment. Specifically, the invention provides for use of biometric devices as inputs to PLC processes or PLC controlled apparatuses or systems, input modules (i.e., IO module), or Human Machine Interface (HMI) connections, to manage access security in the industrial automation system or environment. The system places a restriction of a user's interaction with a PLC process and its associated hardware, based on the user's physical characteristics.

A biometric authentication device is provided as a direct input to a PLC. The PLC may be used to control or operate, for example, an apparatus in a factory. Alternatively, the biometric device may be connected to an IO module, which in turn may be connected to a PLC, or to a HMI in the automation system. The biometric device would limit access to the PLC (or IO or HMI) by recording and verifying a potential user's identity utilizing the potential user's biological data. This system enhances the security throughout the automation system, and is particularly useful in areas that require tight security, such as the airline industry, or the military.

In one aspect of the invention, a system for providing access to a PLC controlled subcomponent comprises a biometric identification device coupled to an I/O device of an automation system, the I/O device is configured to process input from the biometric identification device and provide an identification code for a user of the biometric identification device. The system also includes a PLC based server configured to receive the identification code generated by the I/O device and process the identification code to determine whether to provide access to a PLC controlled subcomponent of the automation system to the user.

The system for providing access to a PLC controlled subcomponent can further comprise a network connection for connecting the I/O device to the PLC based server to enable the PLC based server to receive the identification code from the I/O device. The network can be, for example, an Ethernet network. Additionally, a computer can be connected to the network connection for controlling and monitoring aspects of the automation system.

A plurality of different biometric devices can be utilized in the system. For example, the device can be configured to recognize vocal output from the user. Alternatively, the device can be configured to scan the user's retna; recognize facial patterns of the user; scan a fingerprint of the user; or map an iris of the user. More complicated devices can be utilized to analyze DNA from a user. Such devices are typically more expensive and would likely be used only for instances that require very high security.

The subcomponent of the automation system can be, for example, a stamping machine. However, a large variety of machines or systems can be utilized with the present invention. Other examples, include utilizing the biometric verification to control access to the maintenance area of a machine or the alert system of a maintenance panel. The system can be utilized to check a user's identity before allowing the user to start or stop a PLC process, or to change or overwrite input or output data in the automation system. Similarly, the present system can be used to control access to the PLC process events and logs.

In another aspect of the invention, a method for allowing access and/or control of a subcomponent of an automation system at the I/O level of the automation system comprises the steps of providing a biometric device proximate a subcomponent of an automation system for generating an input responsive to a user of the biometric device; providing the input to an I/O device of the automation system; processing the input from the biometric device to generate an identification code representative of the user of the biometric device; providing the identification code to a PLC server; and, processing the identification by the PLC server to determine if the user is authorized for to utilize the subcomponent. This method can also comprise comparing the identification code received by the PLC server with a plurality of authorized codes stored in a memory accessible to the PLC server; and generating a signal by the PLC server to the subcomponent to activate the subcomponent upon a determination that the identification code matches one of the plurality of authorized codes.

Additionally, the method may include providing a network connecting the I/O device and the PLC server for providing the identification code to the PLC server.

Other systems, methods, features, and advantages of the present invention will be, or will become, apparent to one having ordinary skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a timing chart or diagram illustrating the signal processing sequencing or flow of a system in accordance with the present invention;

FIG. 2 is a graphical illustration of a various biometric input device options that can be utilized in the system of FIG. 1; and,

FIG. 3 is a block diagram of the a system in accordance with the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspects of the invention to the embodiments illustrated.

The present system 10 provides for the use of biometric analysis techniques to allow for access and/or control of specific portions or subcomponents of an industrial automation system or environment. The specific portions may be particular apparatuses, machinery, I/O devices, or other subsystems or components of the automation system such as, for example, those utilizing PLCs, IO modules, or Human Machine Interfaces. The biometric analysis is utilized to positively identify a potential user for the specific portion of the automation system, to ensure that the user has the rights for such use, and to manage access and control of the various subcomponents of the automation system.

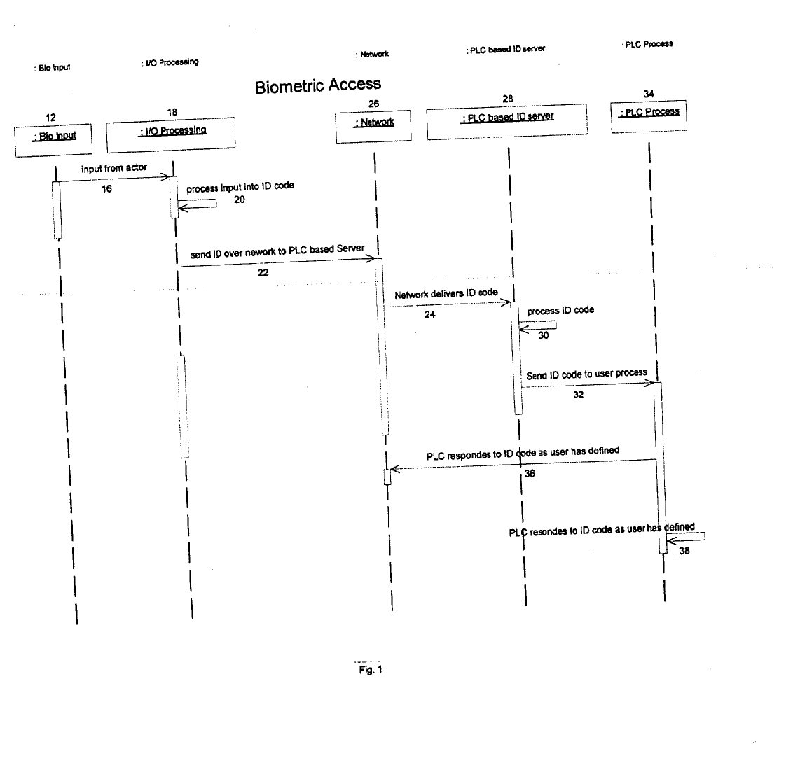

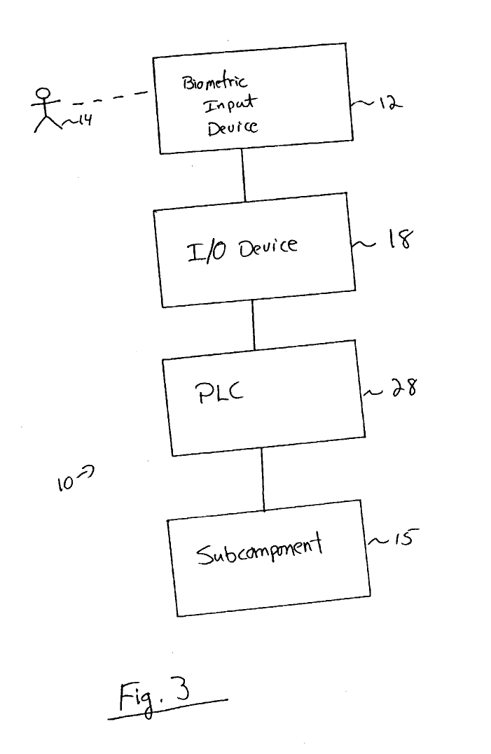

As illustrated in FIGS. 1-3, the present system 10 includes a biometric input device 12 for providing a biometric analysis of a user or actor 14 desiring access and/or control to a subcomponent 15 of the automation system. The biometric input device 12 is utilized to generate a biometric input signal 16 from the user 14. The biometric input signal 16 is provided to an Input/Output (i.e., “I/O”) processing device 18 which processes the input signal 16 into an identification (i.e., “ID”) code 20 (which sometimes may simply be referred to as the “ID”).

The ID code 20 is sent 22 to a network connection 26 which forwards 24 the ID code 20 to a PLC based ID server 28. The PLC based ID server 28 processes the ID code 20 to determine whether to allow the user 14 to have access or control. In this regard, the ID code is compared to previously recorded identification information stored in a database or other memory associated with the PLC server 28. If the user 14 is positively identified as having rights to access or control of the subcomponent 15, the ID code 20 is transmitted 32 to a PLC 34 associated with operation of the subcomponent. The PLC 34 provides a response 36 to the user 14 over the network connection 26, and transmit a signal 38 to the subcomponent granting access or control to the user 14.

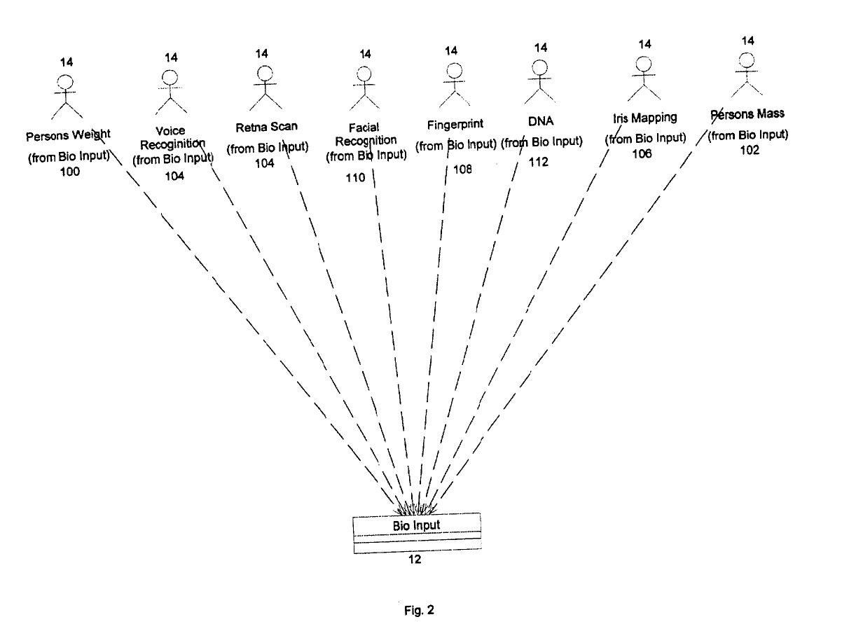

As illustrated in FIG. 2, a large variety of biometric devices 12 can be utilized with the present system. For example, the biometric device 12 may be configured to measure the user's weight 100 or body mass 102. However, such simplistic devices (although likely cheaper and/or more durable than more sophisticated biometric devices) are not extremely accurate with respect to positively identifying a particular user or separating one user from another. Moreover, the user's weight or body mass may fluctuate from day to day, which would inhibit proper identification.

Preferably, more sophisticated devices 12 will be employed with the system. For example, the biometric device 12 may be configured for voice recognition 104. The user would be required to vocalize a particular word or statement, which would be converted or processed into an ID code 20 for use in the system. The system may provide additional security by maintaining the word or statement as a secret password, and/or varying the password on occasion as appropriate.

Other sophisticated biometric devices 12 may rely on recognition of features unique to a user. For example, the device may scan the user's retina 104, iris 106 or fingerprint 108. Alternatively, the device 12 may be configured for facial recognition 110 or a user. Even more sophisticated devices 12 may utilize the user's DNA 112 for identification.

In each instance, the biometric device 12, is utilized to create an identification code 20 that is provided to the PLC based ID server 28. The ID code 20 is processed and compared with ID codes stored in a memory associated with the ID server 28. If the ID code 20 generated by the biometric device 12, matches a stored code, the ID Server 28 will provide a signal to initiate or allow access or control of the particular subcomponent at issue. The system can be set up so that certain users of the system are only granted access and/or control to particular subcomponents. Similarly, the system can be configured for limiting the amount of control (upon proper identification) for certain users.

It should be emphasized that the above-described embodiments of the present invention, particularly, any “preferred@ embodiments, are merely possible examples of implementations, merely setting forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention and protected by the following claims.

I claim:

1. A system for providing access to a PLC controlled subcomponent comprising:
a biometric identification device coupled to an I/O device of an automation system, the I/O device configured to process input from the biometric identification device and provide an identification code for a user of the biometric identification device; and,
a PLC based server configured to receive the identification code generated by the I/O device and process the identification code to determine whether to provide access to a PLC controlled subcomponent of the automation system to the user.

2. The system for providing access to a PLC controlled subcomponent of claim 1, further comprising:
a network connection for connecting the I/O device to the PLC based server to enable the PLC based server to receive the identification code from the I/O device.

3. The system for providing access to a PLC controlled subcomponent of claim 2, further comprising:
a computer connected to the network connection for controlling and monitoring aspects of the automation system.

4. The system for providing access to a PLC controlled subcomponent of claim 2 wherein the network is an Ethernet.

5. The system for providing access to a PLC controlled subcomponent of claim 1, wherein the biometric device is configured to recognize vocal output from the user.

6. The system for providing access to a PLC controlled subcomponent of claim 1, wherein the biometric device is configured to scan the user's retna.

7. The system for providing access to a PLC controlled subcomponent of claim 1, wherein the biometric device is configured to recognize facial patterns of the user.

8. The system for providing access to a PLC controlled subcomponent of claim 1, wherein the biometric device is configured to scan a fingerprint of the user.

9. The system for providing access to a PLC controlled subcomponent of claim 1, wherein the biometric device is configured to map an iris of the user.

10. The system for providing access to a PLC controlled subcomponent of claim 1, wherein the biometric device is configured to analyze DNA from a user.

11. The system for providing access to a PLC controlled subcomponent of claim 1, wherein the subcomponent is a stamping machine in the automation system.

12. The system for providing access to a PLC controlled subcomponent of claim 1, wherein the subcomponent is an entry control into a maintenance area of a machine in the automation system.

13. The system for providing access to a PLC controlled subcomponent of claim 1, wherein the system checks a user's identity to allow a PLC process to one of start and stop.

14. The system for providing access to a PLC controlled subcomponent of claim 1, wherein the system checks a user's identity to determine whether to allow the user to one of change and overwrite data.

15. A method for allowing access and/or control of a subcomponent of an automation system at the I/O level of the automation system comprising the steps of:
providing a biometric device proximate a subcomponent of an automation system for generating an input responsive to a user of the biometric device;
providing the input to an I/O device of the automation system;
processing the input from the biometric device to generate an identification code representative of the user of the biometric device;
providing the identification code to a PLC server; and,
processing the identification by the PLC server to determine if the user is authorized for to utilize the subcomponent.

16. The method for allowing access and/or control of a subcomponent of an automation system at the I/O level of the automation system of claim 16, further comprising the steps of:
comparing the identification code received by the PLC server with a plurality of authorized codes stored in a memory accessible to the PLC server;
generating a signal by the PLC server to the subcomponent to activate the subcomponent upon a determination that the identification code matches one of the plurality of authorized codes.

17. The method for allowing access and/or control of a subcomponent of an automation system at the I/O level of the automation system of claim 16, further comprising the step of:
providing a network connecting the I/O device and the PLC server for providing the identification code to the PLC server.

18. The method for allowing access and/or control of a subcomponent of an automation system at the I/O level of the automation system of claim 16, wherein the biometric device is configured to recognize vocal output from the user.

19. The method for allowing access and/or control of a subcomponent of an automation system at the I/O level of the automation system of claim 16, wherein the biometric device is configured to scan the user's retna.

20. The method for allowing access and/or control of a subcomponent of an automation system at the I/O level of the automation system of claim 16, wherein the biometric device is configured to recognize facial patterns of the user.

21. The method for allowing access and/or control of a subcomponent of an automation system at the I/O level of the automation system of claim 16, wherein the biometric device is configured to scan a fingerprint of the user.

23. The method for allowing access and/or control of a subcomponent of an automation system at the I/O level of the automation system of claim 16, wherein the biometric device is configured to map an iris of the user.

24. The method for allowing access and/or control of a subcomponent of an automation system at the I/O level of the automation system of claim 16, wherein the biometric device is configured to analyze DNA from a user.

25. The method for allowing access and/or control of a subcomponent of an automation system at the I/O level of the automation system of claim 16, wherein the subcomponent is a stamping machine.

26. The method for allowing access and/or control of a subcomponent of an automation system at the I/O level of the automation system of claim 16, wherein the subcomponent is a maintenance area of a machine.

27. The method for allowing access and/or control of a subcomponent of an automation system at the I/O level of the automation system of claim 16, further comprising the step of:
allowing the user to one of start and stop a PLC process upon a determination that the identification code matches one of the plurality of authorized codes.

28. The method for allowing access and/or control of a subcomponent of an automation system at the I/O level of the automation system of claim 16, further comprising the step of:
allowing the user to one of change and overwrite data in the automation system upon a determination that the identification code matches one of the plurality of authorized codes.

29. The method for allowing access and/or control of a subcomponent of an automation system at the I/O level of the automation system of claim 16, further comprising the step of:
allowing the user access to a PLC process log in the automation system upon a determination that the identification code matches one of the plurality of authorized codes.
